(19) United States
(12) Patent Application Publication
(10) Pub. No.: US 2015/0220505 A1
(43) Pub. Date: Aug. 6, 2015

(54) ENHANCED AUDIENCE INTERACTION WITH A PRESENTER OF A PRESENTATION

(71) Applicant: International Business Machines Corporation, Armonk, NY (US)

(72) Inventor: Robert C. Weir, Westford, MA (US)

(73) Assignee: International Business Machines Corporation, Armonk, NY (US)

(21) Appl. No.: 14/173,582

(22) Filed: Feb. 5, 2014

(51) Int. Cl. G06F 17/24; G06F 3/0481

(52) U.S. Cl. CPC G06F 17/241; G06F 3/0481

(57) ABSTRACT

A presentation being presented to an audience can be detected, the presentation including a plurality slides presented during the presentation. While the presentation is being presented to the audience, a message can be received from an audience member pertaining to at least one of the plurality of slides presented during the presentation. An association between the message from the audience member and the slide(s) presented during the presentation to which the message pertains can be automatically created. Responsive to detecting the presentation has completed, the message from the audience member pertaining to the slide(s) presented during the presentation can be communicated to the presenter of the presentation in a manner that indicates, independent of text entered into a body or subject line of the message by the audience member, to the presenter the association created between the message and the slide(s) presented during the presentation to which the message pertains.

### BACKGROUND

Arrangements described herein relate to audience interaction with a presenter of a presentation.

Oftentimes a speaker at an event will present a presentation to a group of people attending the event, for example using a presentation program. Members of the audience may desire to interact with the speaker regarding the presentation. Conventional forms of interaction in this context have been limited to a question and answer session following the presentation, a brief discussions following the presentation, and maybe the exchange of business cards with promise of a follow-up.

### SUMMARY

A method includes detecting a presentation being presented to an audience, the presentation including a plurality slides presented during the presentation. While the presentation is being presented to the audience, a message can be received from an audience member pertaining to at least one of the plurality of slides presented during the presentation. An association between the message from the audience member and the at least one of the plurality of slides presented during the presentation to which the message pertains can be automatically created using a processor. Responsive to detecting the presentation has completed, the message from the audience member pertaining to the at least one of the plurality of slides presented during the presentation can be communicated to the presenter of the presentation in a manner that indicates, independent of text entered into a body or subject line of the message by the audience member, to the presenter the association created between the message and the at least one of the plurality of slides presented during the presentation to which the message pertains.

A system includes a processor programmed to initiate executable operations. The executable operations include detecting a presentation being presented to an audience, the presentation including a plurality slides presented during the presentation. While the presentation is being presented to the audience, a message can be received from an audience member pertaining to at least one of the plurality of slides presented during the presentation. An association between the message from the audience member and the at least one of the plurality of slides presented during the presentation to which the message pertains can be automatically created. Responsive to detecting the presentation has completed, the message from the audience member pertaining to the at least one of the plurality of slides presented during the presentation can be communicated to the presenter of the presentation in a manner that indicates, independent of text entered into a body or subject line of the message by the audience member, to the presenter the association created between the message and the at least one of the plurality of slides presented during the presentation to which the message pertains.

A computer program includes a computer readable storage medium having program code stored thereon. The program code is executable by a processor to perform a method. The method includes detecting, by the processor, a presentation being presented to an audience, the presentation including a plurality slides presented during the presentation. While the presentation is being presented to the audience, a message can be received, by the processor, from an audience member pertaining to at least one of the plurality of slides presented during the presentation. An association between the message from the audience member and the at least one of the plurality of slides presented during the presentation to which the message pertains can be automatically created by the processor. Responsive to detecting the presentation has completed, the message from the audience member pertaining to the at least one of the plurality of slides presented during the presentation can be communicated, by the processor, to the presenter of the presentation in a manner that indicates, independent of text entered into a body or subject line of the message by the audience member, to the presenter the association created between the message and the at least one of the plurality of slides presented during the presentation to which the message pertains.

### BRIEF DESCRIPTION OF THE SEVERAL VIEWS OF THE DRAWINGS

FIG. 1 is a block diagram illustrating an example of a presentation system.

FIG. 2 is a block diagram illustrating example architecture for an interaction server.

FIG. 3 is a flow chart illustrating an example of a method of enhanced audience interaction with a presenter of a presentation.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to enhanced audience interaction with a presenter of a presentation. In accordance with the inventive arrangements disclosed herein, during a presentation presented to an audience, presentation metadata related to the presentation can be communicated to members of the audience (i.e., to their mobile communication devices). The presentation metadata can indicate information about the presenter, one or more uniform resource identifiers (URIs) (e.g., uniform resource locators (URLs)) to websites where the audience members can obtain information related to the presentation, one or more URIs directed to information related to the presentation, an email address to which the audience members can send emails with questions and/or comments about the presentation and/or a messaging address to which audience members can send text messages and/or instant messages with questions and/or comments about the presentation.

Emails, text messages and/or instant messages (collectively referred herein as “messages”) that are received during the presentation can be associated with the presentation. In illustration, an association can be created between each received message and one or more slides presented during the presentation to which the message pertains. Responsive to detecting the presentation has completed, the messages from the audience members can be communicated to the presenter of the presentation in a manner that indicates to the presenter the association created between the messages and slides presented during the presentation to which the messages pertain. Accordingly, the presenter can review the messages in the context of the slides with which the messages are associated. This context can greatly facilitate the presenter's understanding of the messages.

Several definitions that apply throughout this document now will be presented.

As defined herein, the term “presentation” means a presentation presented to an audience.

As defined herein, the term “live presentation” means a presentation presented to an audience in a geographic location where a presenter of the presentation is geographically located when the presenter presents the presentation. In this regard, a presentation presented in a web conference is not a “presentation” and a presentation presented in a teleconference is not a “presentation.”

As defined herein, the term “audience” means a group of people viewing the presentation.

As defined herein, the term “presenter” means a person (i.e., a human being) who is presenting a presentation.

As defined herein, the term “audience member” means a person (i.e., a human being) who is a member of an audience viewing a presentation.

As defined herein, the term “presentation program” means a software package configured to display information in the form of a slide show. A presentation program can be hosted locally on a processing system or hosted on a website accessed by a processing system. Examples of presentation programs include, but are not limited to, IBM® Lotus® Symphony® Presentations, Microsoft® PowerPoint®, Apache OpenOffice™ Impress, SoftMaker® Presentations, Corel® Presentations, Power Presentation™, Ability™ Presentation, Prezi™ Pro, ProPresenter®, MediaShout® and Google Drive™ Presentation.

As defined herein, the term “slide” means information presented on a display or projected on a screen by a presentation program during a slide show. A slide may include text, one or more images, audio, video, animation and/or multimedia.

As defined herein, the term “presentation metadata” means data related to a presentation.

As defined herein, the term “message” means a text message, instant message and/or electronic mail (email).

As defined herein, the term “plug-in” means a software component that adds a specific feature to an existing application. A plug-in also may be referred to as an “extension,” an “add-on” or an “addon.”

As defined herein, the term “automatically” means without user intervention.

As defined herein, the term “user” means a person (i.e., a human being).

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), an application specific integrated circuit (ASIC) and a controller.

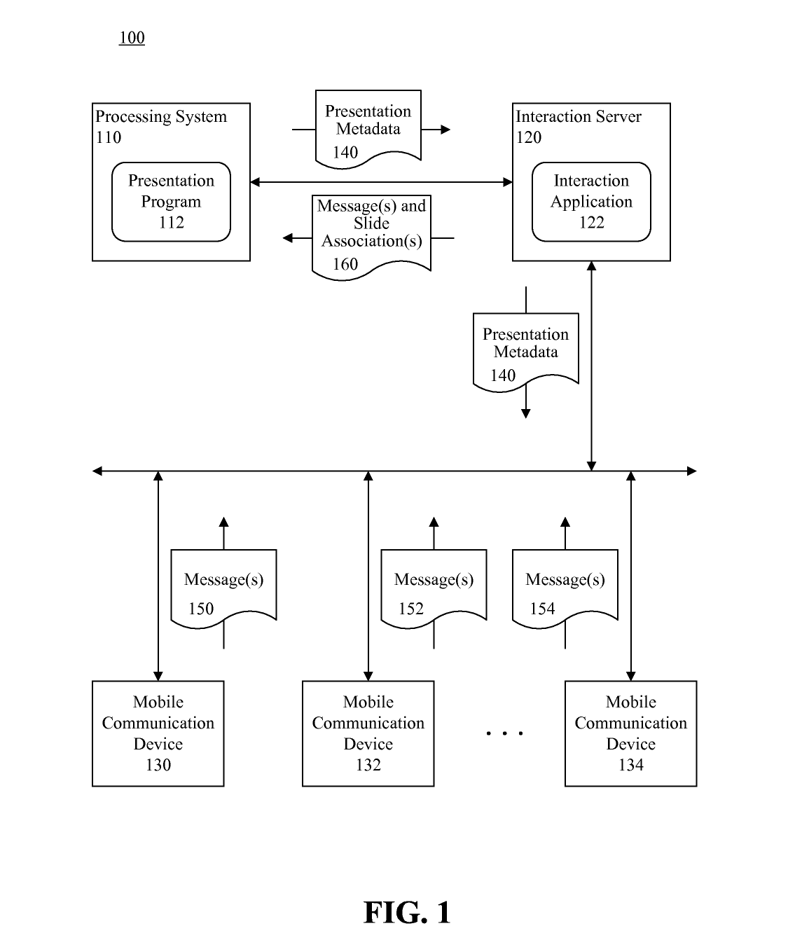

FIG. 1 is a block diagram illustrating an example of a presentation system 100. The presentation system can include a processing system 110 including at least one processor and memory. In one arrangement, the processing system can be a computer (e.g., a workstation, a desktop computer, a laptop computer, a notebook computer, a netbook, a tablet computer, etc.) that is operatively coupled to a display on which a presentation is presented or a projector that projects a presentation onto a screen. In another arrangement, the processing system 110 can be a projector configured to project a presentation onto a screen independently of an external computer. In yet another arrangement, the processing system 110 can be a display configured to present a presentation on the display independent of an external computer.

In one aspect, the processing system 110 can include a presentation program 112. The presentation program 112 can be executed by the processing system 110 to present the presentation. In another aspect, the processing system 110 can access the presentation program 112 from another processing system. For example, the processing system 110 can access the presentation program 112 from a website and/or execute the presentation program 112 as a web-based service.

The presentation system 100 also can include an interaction server 120 including at least one processor and memory. The interaction server 120 can include an interaction application 122 that facilitates interaction of audience members with the presentation and/or presenter as will be described herein.

The presentation system 100 also can include a plurality of mobile communication devices 130, 132, 134 via which audience members may interact with the presentation and/or presenter as will be described herein. Examples of mobile communication devices include, but are not limited to, mobile computers (e.g., laptop computers, tablet computers and the like), smart phones, personal digital assistants, etc.

The processing system 110 and the mobile communication devices 130-134 can be communicatively linked to the interaction server 120 via a suitable communication network (not shown). The communication network is the medium used to provide communications links between various elements of the presentation system 100. The communication network may include connections, such as wire, wireless communication links, or fiber optic cables. The communication network can be implemented as, or include, any of a variety of different communication technologies such as a wide area network (WAN), a local area network (LAN), a wireless network, a mobile network, a Virtual Private Network (VPN), the Internet, the Public Switched Telephone Network (PSTN), and/or the like.

In operation, the processing system 110, via the presentation program 112, presents the presentation to an audience. In one arrangement, the presentation can be a live presentation. Prior to a start of the presentation, when the presentation starts, or subsequent to the presentation starting, the processing system 110 can provide to the interaction server 120 presentation metadata 140 related to the presentation. For example, an application programming interface (API) can be installed on the processing system for use with the presentation program 112 to facilitate entry of the presentation metadata 140 and communication of the presentation metadata 140 to the interaction server 120. The presentation metadata 140 can be stored to a computer readable storage medium that is a component of the interaction server 120 or to which the interaction server 120 is communicatively linked. In another arrangement, the presentation metadata 140 can be communicated to the interaction server 120 from another processing system (not shown). For example, prior to starting the presentation, the presenter or another person can upload the presentation metadata 140 to the interaction server 120.

The interaction server 120 can communicate the presentation metadata 140 to one or more of the mobile communication devices 130-134. In illustration, prior to a start of the presentation, when the presentation starts, or subsequent to the presentation starting, a URI can be provided to audience members that the audience members can use to retrieve the presentation metadata 140. For example, the URI can be presented to the audience members on a handout, presented on a display being viewed by the audience members, presented on a poster available for viewing, or the like. In one aspect, the URI can be presented on a first slide shown in the presentation. When the audience members access the URI, or otherwise query the interaction server 120, the presentation metadata 140 can be communicated from the interaction server 120 (e.g., using the interaction application 122) to their respective mobile communication devices 130-134. The presentation metadata 140 can be presented on the mobile communication devices 130-134 via web browsers, word processors, or any other suitable applications. Optionally, via the URI, one or more plug-ins can be communicated to the mobile communication devices 130-134 for installation on the mobile communication devices 130-134 for use with the web browsers, word processors, presentation programs, presentation viewers, or other applications installed on the mobile communication devices 130-134. The plug-in(s) can facilitate audience member interaction with the presentation, communication of messages pertaining to the presentation, etc.

In one arrangement, the presentation metadata 140 can include information about the presenter, contact information for the presenter, such as the presenter's user name(s) on one or more social networking sites, the presenter's email address, the presenter's text messaging address, the presenter's instant messaging address, the presenter's telephone number, and/or other contact information. Further, an email address, text messaging address and/or instant messaging address for the presenter that is/are specifically associated with the presentation can be provided in the presentation metadata 140. Accordingly, any messages that are sent to any of those addresses can be identified as pertaining to the presentation and sent to, or forwarded to, the interaction server 120 (e.g., to the interaction application 122).

The presentation metadata 140 also can include a hyperlink audience members can select to download a copy of the presentation, hyperlinks to additional information about the topic of the presentation and/or a hyperlink to a chat room to discuss the presentation with other audience members during or after the presentation. The presentation metadata 140 also can include a hyperlink to a website where audience members can register to receive mail and/or email from the presenter, etc.

The presentation can include a plurality of slides. As noted, each slide may include text, one or more images, audio, video, animation and/or multimedia. During the presentation, the presenter can interact with the presentation program 112 to advance through the slides. Each time the presenter advances the presentation from one slide to another slide, the presentation program 112, or an API associated with the presentation program 112, can generate an identifier that identifies the other slide and a time stamp indicating when the other slide is presented. Optionally, an identifier that identifies the previous slide and a time stamp indicating when the previous slide was advanced away from also can be generated. The processing system 110 (e.g., the presentation program 112 or API) can communicate such identifiers to the interaction server 120 (e.g., to the interaction application 122), which can store the identifiers in a suitable data table on a computer readable storage medium associated with the interaction server 120. Accordingly, the interaction application 122 will know precisely when each slide in the presentation is presented.

During the presentation, audience members may choose to send messages 150, 152, 154 to the presenter providing feedback on the presentation and/or presenting questions regarding the presentation. Such messages can be sent to the email address, text messaging address, instant messaging address or telephone number specifically associated with the presentation, and delivered to the interaction server 120 (e.g., to the interaction application 122). At least some of the messages may pertain to specific slides that are presented in the presentation. Accordingly, when the interaction application 122 receives a message from an audience member pertaining to the presentation, the interaction application 122 can automatically create an association between the message and the slide of the presentation that is presented when the message is generated by the audience member.

In one arrangement, an API installed on the audience member's mobile communication device 130 can include in a header or footer of the message 150 a time stamp indicating when the audience member began composing the message 150. The interaction application 122 can process this time stamp to identify which slide was being presented when the user began composing the message 150 based on the time stamps associated with the slides. The interaction server 120 can automatically create an association between the message 150 and the identified slide.

In another arrangement, the interaction application 122 can identify a time stamp indicating when the message 150 was sent by the mobile communication device 130 or a time stamp indicating when the message 150 was received by the interaction application 122. The interaction application 122 can process this time stamp to identify which slide was being presented when the audience member sent the message 150 or when the message 150 was received based on the time stamps associated with the slides. Again, the interaction server 120 can automatically create an association between the message 150 and the identified slide.

In yet another arrangement, for example if the audience member has downloaded a copy of the presentation to his/her mobile communication device 130, the audience member can indicate one or more slides to which the message pertains. For example, the audience member can select one or more slides in the downloaded copy of the presentation, and choose to generate a message 150 pertaining to the selected slide(s). In illustration, a plug-in associated with a presentation program or presentation viewer executing on the mobile communication device 130 can provide options that allow the audience member to select one or more slides and compose a message 150 pertaining to such slide(s). In one aspect, the selected slide(s) can be indicated by one or more identifiers placed by the plug-in in a header or footer of the message, in a subject line of the message and/or in a body of the message. When the interaction application 122 receives the message 150 from the audience member, the interaction application 122 can process such identifier(s) to identify the slide(s) to which the message 150 pertains and automatically create an association between the message and such slide(s).

At some point the presenter can close the presentation, thus indicating the presentation has completed, or the presenter can indicate that the presentation has completed in another manner, for example by selecting a menu item presented by the presentation program 112 or closing the presentation program 112. In response, the processing system 110 can communicate a message to the interaction server 120 indicating the presentation is complete. Responsive to detecting the presentation has completed, the interaction application 122 can communicate to the presenter of the presentation (e.g., to the processing system 110) the message(s) 160 from the audience member(s) pertaining to the presentation.

As noted, at least some of these messages 160 may pertain to one or more slides presented during the presentation. The interaction application 122 can communicate such message(s) 160 to the presenter in a manner that indicates to the presenter associations created between the respective messages and the slide(s) to which the respective messages pertain(s). Such slide associations can be independent of text entered into a body or subject line of the message by the audience member. For example, in one arrangement, a reference to each slide to which a particular message 160 pertains can be added to the message 160 by the interaction application 122. In this regard, the messages 160 can be configured to indicate to the processing system 110 to store the message in a manner that associates the message with the at least one of the plurality of slides presented during the presentation to which the message pertains.

In illustration, the interaction server 120 can add the reference(s) to each slide to which the respective message(s) pertain to the subject line of the message 160 or at the top of the body of the message 160. In another arrangement, the interaction application 122 can add reference to one or more slides to which a particular message 160 pertains to a header or footer of the message 160. When the processing system 110 receives such messages 160 from the interaction server 120, the processing system 110 can store such messages in a manner that associates the respective messages 160 with the slide(s) presented during the presentation to which the respective messages pertain. Accordingly, the presenter can review the messages in the context of the slides with which the messages are associated. This context can greatly facilitate the presenter's understanding of the messages.

For example, the associations created between the messages 160 and the slides to which they pertain can be configured to indicate to a plug-in associated with the processing system (e.g., the presentation program 112) to create a link between each message 160 and the slide(s) to which the message 160 pertains. In illustration, a hyperlink to each message 160 pertaining to a particular slide can be added to that slide, and/or a hyperlink to each slide to which a particular message 160 pertains can be added to the message 160. In another aspect, the associations created between the messages 160 and the slides to which they pertain can be configured to indicate to the plug-in to insert the messages 160 into the presentation in a manner that associates the messages 160 with the respective slide(s) to which the messages 160 pertain. For example, the messages 160 can be configured to be presented above, below or next to the slides to which the messages 160 pertain or inserted on new slides positioned in the presentation before or after the respective slides to which the messages 160 pertain.

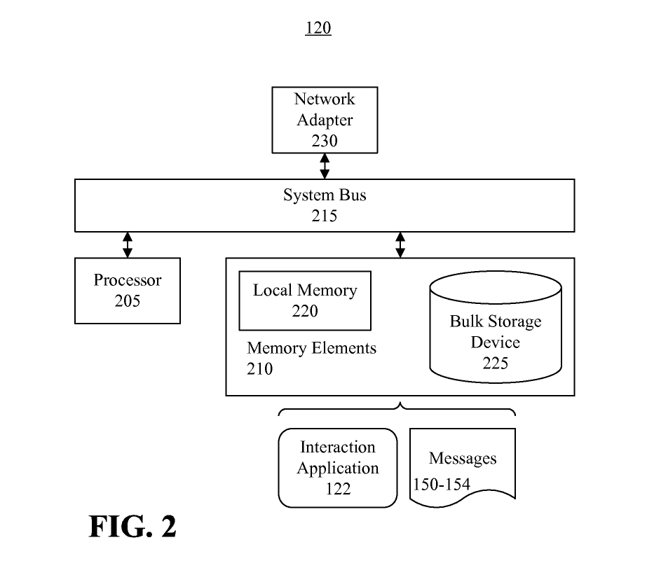

FIG. 2 is a block diagram illustrating example architecture for the interaction server 120. The interaction server 120 can include at least one processor 205 (e.g., a central processing unit) coupled to memory elements 210 through a system bus 215 or other suitable circuitry. As such, the interaction server 120 can store program code within the memory elements 210. The processor 205 can execute the program code accessed from the memory elements 210 via the system bus 215. It should be appreciated that the interaction server 120 can be implemented in the form of any system including a processor and memory that is capable of performing the functions and/or operations described within this specification. For example, the interaction server 120 can be implemented as a computer, a workstation, a desktop computer, a mobile computer, a laptop computer, a tablet computer, and so on.

The memory elements 210 can include one or more physical memory devices such as, for example, local memory 220 and one or more bulk storage devices 225. Local memory 220 refers to RAM or other non-persistent memory device(s) generally used during actual execution of the program code. The bulk storage device(s) 225 can be implemented as a hard disk drive (HDD), solid state drive (SSD), or other persistent data storage device. The interaction server 120 also can include one or more cache memories (not shown) that provide temporary storage of at least some program code in order to reduce the number of times program code must be retrieved from the bulk storage device 225 during execution.

One or more network adapters 230 can be coupled to interaction server 120 to enable interaction server 120 to become coupled to other systems, computer systems, remote printers, and/or remote storage devices through intervening private or public networks. Modems, cable modems, transceivers, and Ethernet cards are examples of different types of network adapters 230 that can be used with interaction server 120.

As pictured in FIG. 2, the memory elements 210 can store the components of the interaction server 120 of FIG. 1, namely the interaction application 122 and messages 150-154 of FIG. 1. Being implemented in the form of executable program code, the interaction application 122 can be executed by the interaction server 120 and, as such, can be considered part of the interaction server 120. Moreover, the interaction application 122 and messages 150-154 are functional data structures that impart functionality when employed as part of the interaction server 120.

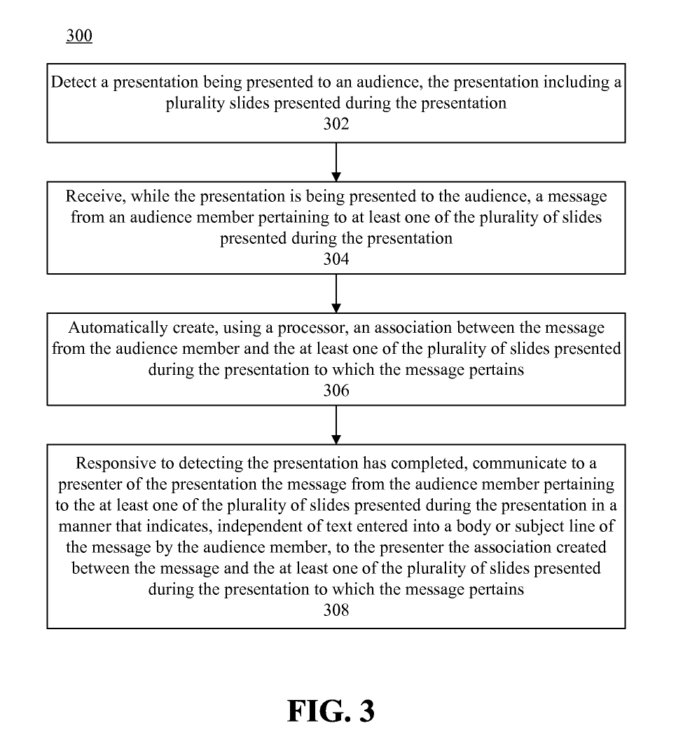

FIG. 3 is a flow chart illustrating an example of a method 300 of enhanced audience interaction with a presenter of a presentation. At step 302, a presentation being presented to an audience can be detected. The presentation can include a plurality of slides presented during the presentation. At step 304, while the presentation is being presented to the audience, a message can be received from an audience member pertaining to at least one of the plurality of slides presented during the presentation. At step 306, an association between the message from the audience member and the at least one of the plurality of slides presented during the presentation to which the message pertains can be automatically created using a processor. At step 308, responsive to detecting the presentation has completed, the message from the audience member pertaining to the at least one of the plurality of slides presented during the presentation can be communicated to the presenter in a manner that indicates, independent of text entered into a body or subject line of the message by the audience member, to the presenter the association created between the message and the at least one of the plurality of slides presented during the presentation to which the message pertains.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-8. (canceled)

9. A system, comprising:
a processor programmed to initiate executable operations comprising:
detecting a presentation being presented to an audience, the presentation comprising a plurality slides presented during the presentation;
receiving, while the presentation is being presented to the audience, a message from an audience member pertaining to at least one of the plurality of slides presented during the presentation;
automatically creating, using a processor, an association between the message from the audience member and the at least one of the plurality of slides presented during the presentation to which the message pertains; and
responsive to detecting the presentation has completed, communicating to a presenter of the presentation the message from the audience member pertaining to the at least one of the plurality of slides presented during the presentation in a manner that indicates, independent of text entered into a body or subject line of the message by the audience member, to the presenter the association created between the message and the at least one of the plurality of slides presented during the presentation to which the message pertains.

10. The system of claim 9, the executable operations further comprising:
receiving, each time the presentation advances from one slide to another slide, an identifier that identifies the other slide and a time stamp indicating when the other slide is presented during the presentation.

11. The system of claim 10, wherein creating, using a processor, the association between the message from the audience member and the at least one of the plurality of slides presented during the presentation to which the message pertains comprises:
identifying a slide of the presentation being presented when the message is generated by the audience member and creating the association between the message and that slide.

12. The system of claim 9, wherein creating, using a processor, the association between the message from the audience member and the at least one of the plurality of slides presented during the presentation to which the message pertains comprises:
receiving from the audience member, with the message, an indication of the at least one of the plurality of slides presented during the presentation and creating the association between the message and that slide.

13. The system of claim 9, wherein creating, using a processor, the association between the message from the audience member and the at least one of the plurality of slides presented during the presentation to which the message pertains comprises:
communicating the message to a processing system hosting a presentation manager that presents the presentation to the audience, wherein, as communicated to the processing system, the message is configured to indicate to the processing system to store the message in a manner that associates the message with the at least one of the plurality of slides presented during the presentation to which the message pertains.

14. The system of claim 13, wherein, as communicated to the processing system, the message is configured to indicate to a plug-in associated with the processing system to create a link between message and the at least one of the plurality of slides to which the message pertains.

15. The system of claim 13, wherein, as communicated to the processing system, the message is configured to indicate to a plug-in associated with the processing system to insert the message into the presentation in a manner that associates the message with the at least one of the plurality of slides to which the message pertains.

16. The system of claim 9, the executable operations further comprising:
communicating metadata associated with the presentation to at least one mobile communication device being used by at least one of the audience members.

17. A computer program product comprising a computer readable storage medium having program code stored thereon, the program code executable by a processor to perform a method comprising:
detecting, by the processor, a presentation being presented to an audience, the presentation comprising a plurality slides presented during the presentation;
receiving, by the processor, while the presentation is being presented to the audience, a message from an audience member pertaining to at least one of the plurality of slides presented during the presentation;
automatically creating, by the processor, an association between the message from the audience member and the at least one of the plurality of slides presented during the presentation to which the message pertains; and
responsive to detecting the presentation has completed, communicating, by the processor, to a presenter of the presentation the message from the audience member pertaining to the at least one of the plurality of slides presented during the presentation in a manner that indicates, independent of text entered into a body or subject line of the message by the audience member, to the presenter the association created between the message and the at least one of the plurality of slides presented during the presentation to which the message pertains.

18. The computer program product of claim 17, the method further comprising:
receiving, each time the presentation advances from one slide to another slide, an identifier that identifies the other slide and a time stamp indicating when the other slide is presented during the presentation.

19. The computer program product of claim 18, wherein
automatically creating, using a by the processor, the association between the message from the audience member and the at least one of the plurality of slides presented during the presentation to which the message pertains comprises:
identifying a slide of the presentation being presented when the message is generated by the audience member and creating the association between the message and that slide.

20. The computer program product of claim 17, wherein
automatically creating, by the processor, the association between the message from the audience member and the at least one of the plurality of slides presented during the presentation to which the message pertains comprises:
receiving from the audience member, with the message, an indication of the at least one of the plurality of slides presented during the presentation and creating the association between the message and that slide.

21. The computer program product of claim 17, wherein automatically creating, by the processor, the association between the message from the audience member and the at least one of the plurality of slides presented during the presentation to which the message pertains comprises:
communicating the message to a processing system hosting a presentation manager that presents the presentation to the audience, wherein, as communicated to the processing system, the message is configured to indicate to the processing system to store the message in a manner that associates the message with the at least one of the plurality of slides presented during the presentation to which the message pertains.

22. The computer program product of claim 21, wherein, as communicated to the processing system, the message is configured to indicate to a plug-in associated with the processing system to create a link between message and the at least one of the plurality of slides to which the message pertains.

23. The computer program product of claim 21, wherein, as communicated to the processing system, the message is configured to indicate to a plug-in associated with the processing system to insert the message into the presentation in a manner that associates the message with the at least one of the plurality of slides to which the message pertains.

24. The computer program product of claim 17, the method further comprising:
communicating metadata associated with the presentation to at least one mobile communication device being used by at least one of the audience members.
